(19) United States
(12) Patent Application Publication
(10) Pub. No.: US 2026/0043724 A1
(43) Pub. Date: Feb. 12, 2026

(54) COLLET-CHUCK SYSTEM FOR UNIAXIAL TESTING

(71) Applicants: BOARD OF TRUSTEES OF MICHIGAN STATE UNIVERSITY, East Lansing, MI (US); Engineering & Software Consultants, LLC, Reston, VA (US)

(72) Inventors: Muhammed Emin Kutay, Okemos, MI (US); Michael Elwardany, Herndon, VA (US); Raghu Satyanarayana, Chantilly, VA (US)

(21) Appl. No.: 19/101,626

(22) PCT Filed: Aug. 9, 2023
(86) PCT No.: PCT/US2023/029798

§ 371 Date: Feb. 6, 2025

Related U.S. Application Data
(60) Provisional application No. 63/396,332, filed on Aug. 9, 2022.

(51) Int. Cl. G01N 3/08; G01N 3/04

(52) U.S. Cl. CPC G01N 3/08; G01N 3/04; G01N 2203/0007; G01N 2203/0017; G01N 2203/0019; G01N 2203/0222; G01N 2203/04; G01N 2203/0647

(57) ABSTRACT

The disclosure relates to apparatus and methods for uniaxial testing of a solid specimen, such as an asphalt or asphalt concrete specimen. The apparatus provides a simplified and accelerated procedure for mounting and testing asphalt mixture samples and other solid specimens under uniaxial tension and/or compression, in particular to measure corresponding uniaxial strain and/or fatigue in the specimen. The apparatus incorporates two opposing collet-chuck elements to rapidly mount and fixedly hold a solid specimen in place in a loading system to apply uniaxial loads. The disclosure further relates to an off-specimen means for measuring strain in a specimen using optical imaging in which successive time series images of a specimen during uniaxial loading can be analyzed to determine displacements and corresponding strains.

### CROSS REFERENCE TO RELATED APPLICATION

Priority is claimed to U.S. Provisional Application No. 63/396,332 filed Aug. 9, 2022, which is incorporated herein by reference in its entirety.

### STATEMENT OF GOVERNMENT INTEREST

This invention was made with government support under contract number 6913G621P800054 awarded by the Department of Transportation. The government has certain rights in the invention.

### FIELD OF THE DISCLOSURE

The disclosure relates to apparatus and methods for uniaxial testing of a solid specimen, including but not limited to an asphalt concrete specimen. The apparatus incorporates two opposing collet-chuck elements to rapidly mount and fixedly hold a solid specimen in place in a loading system to apply and/or torsional uniaxial loads.

### BACKGROUND OF THE DISCLOSURE

For motor vehicle roadways, in particular high-speed highways, fatigue cracking is one of the most common failure modes that limit roadway lifecycles. However, many transportation regulation authorities do not require fatigue cracking testing in their design specifications for mixes such as asphalt concrete mixes, primarily because a simple and robust fatigue test is not available. The current fatigue cracking tests are lengthy, cumbersome, and expensive. Extensive material requirements for sample preparation, difficulty in meeting the air void target, the large number of samples needed for testing, common premature “end-failures” (leading to excessive sample preparation time and consumption of material), and high equipment costs are some of the challenges encountered when running various known fatigue cracking tests for roadway materials. Hence, there are currently no simple alternatives for balanced mix design approaches.

Numerous laboratory tests have been developed to assess the fatigue and fracture resistance of asphalt mixtures. Common tests include flexural tests (e.g., center point and third-point loading tests, cantilever beam rotating test, trapezoidal cantilever beam test and four-point bending (4PB) fatigue test) and uniaxial cyclic fatigue tests. The four-point bending (4PB) fatigue test (AASHTO T321) has traditionally been the most common test method to characterize the fatigue resistance of asphalt mixtures. However, 4PB tests are lengthy, cumbersome, and expensive. Extensive material requirements for sample preparation, difficulty in meeting target air void, the large number of samples needed for testing, and excessive equipment costs are some of the challenges encountered when running 4PB tests. As an alternative, uniaxial fatigue (UF) tests (e.g., AASHTO TP107) are gaining wide acceptance for fatigue evaluation of asphalt pavements because of their advantages over the 4PB and other tests. These advantages include homogenous stress-strain distribution through the sample, samples being produced using the Gyratory compactor and straightforward application of the constitutive and continuum mechanics models, such as the simplified-viscoelastic continuum damage (S-VECD) theory. Small specimen geometry (38-mm diameter) provides an efficient way for cyclic fatigue testing and for forensic investigations using side (horizontal) coring from pavement layers (AASHTO TP 133).

Nevertheless, there are also challenges with UF testing. For example, the two ends of the sample need to be cut parallel to meet a tight tolerance, as specified in AASHTO TP 133. Additionally, gluing the end-platens using a gluing jig can be a cumbersome and time-consuming procedure. As a result, many “end-failures” are experienced when sample ends are not cut parallel, or gluing is not done properly. Since the samples are expected to fail in the center, many of the samples and the test results are discarded, leading to excessive sample preparation time and consumption of material. Furthermore, while the UF testing is superior to 4PB testing, it is not currently suitable as a routine testing alternative for balanced mix design approaches. On the other hand, there are several more rapid tests for hierarchical classification of cracking susceptibility of asphalt mixtures (e.g., SCB at intermediate temperature (SCB-Jc), Illinois flexibility index test (I-FIT), Texas overlay test (OT), indirect tensile asphalt cracking (ITC) test (IDEAL-CT)). However, the rapid tests cannot be used to calibrate fatigue models or to integrate material characterization in pavement design and may not be easily integrated in M-E pavement structural analysis (e.g., AASHTOWARE PAVEMENT ME Design software or FLEXPAVE software).

Among numerous cracking tests, two of them stood out in terms of their technical rigor and simplicity for potential use in the balanced mixture design (BMD) concept. These two promising cracking tests are the uniaxial fatigue (also known as AMPT Uniaxial Cyclic Fatigue Test), which is standardized as AASHTO TP 107 & TP 133, and the Texas overlay test which is standardized as Texas DOT Tex-248-F. However, both tests require gluing asphalt mixture samples on platens, which slows down overall sample preparation and testing. Axial strain of the samples in AMPT Cyclic Fatigue Test is measured using spring loaded linear variable differential transformers (LVDTs) by gluing LVDT tabs on the specimen and attaching the LVDTs on these tabs. The process of mounting LVDTs on the samples increases the sample preparation time as well as the temperature equilibration time.

### SUMMARY

The disclosed apparatus and related methods for uniaxial testing of a solid specimen (such as an asphalt or asphalt concrete specimen, as well as other composite materials and polymers) address limitations of current testing methods by providing a simplified and accelerated procedure for mounting and testing asphalt mixture samples in uniaxial fatigue and Texas-overlay tests in an AMPT device to reduce the overall testing time while providing high-quality test results. The disclosed apparatus incorporates a clamping system such as two opposing collet-chuck elements to rapidly mount and fixedly hold a solid specimen in place for testing, thereby eliminating the need for glued endplates currently used in standard test methods (e.g., AASHTO TP 132).

In one aspect, the disclosure relates to an apparatus for uniaxial testing (e.g., uniaxial strain testing) and/or torsional testing in a solid specimen, the apparatus comprising: a loading system (e.g., asphalt mixture performance tester (AMPT); conventional tensile testing apparatus such as a universal testing machine (UTM)) adapted to apply uniaxial tension and optionally uniaxial compression along a uniaxial direction (e.g., single linear direction); and a first collet-chuck element and a second collet-chuck element mounted to the loading system in an opposing (or facing) orientation, the elements being adapted to receive a solid specimen (e.g., test material or sample to be secured by the opposing elements); wherein the loading system is adapted to apply uniaxial tension and optionally uniaxial compression to a solid specimen (e.g., along a cylindrical axis of the specimen) secured by the first and second collet-chuck elements.

In another aspect, the disclosure relates to an apparatus for uniaxial testing (e.g., uniaxial strain testing) in a solid specimen, the apparatus comprising: a loading system (e.g., asphalt mixture performance tester (AMPT); conventional tensile testing apparatus such as a universal testing machine (UTM)) adapted to apply uniaxial tension and optionally uniaxial compression along a uniaxial direction (e.g., single linear direction); a first support element and a second support element mounted to the loading system in an opposing (or facing) orientation, the elements being adapted to receive a solid specimen (e.g., test material or sample to be secured by the opposing elements); and one or more off-specimen strain sensors adapted to measure (uniaxial) strain in the specimen (e.g., when the specimen is present); wherein the loading system is adapted to apply uniaxial tension and optionally uniaxial compression to a solid specimen (e.g., along a cylindrical axis of the specimen) secured by the first and second collet-chuck elements. The first and/or second support elements can be first and second collet-chuck elements as disclosed herein. In some refinements, the first and/or second support elements can be other than collet-chuck elements, for example first and second endplates adapted to receive and secure/mount a specimen therebetween using glue or other strong adhesive between the specimen's axial end surfaces and the endplates.

Various refinements of the apparatus for uniaxial testing are possible.

In a refinement, the loading system is adapted to apply uniaxial tension and uniaxial compression along the uniaxial direction (e.g., to perform either a cyclic tension/compression test or to perform a monotonic tension test), and optionally to apply rotational torsion (e.g., to perform torsion testing).

In a refinement, the loading system is adapted to apply uniaxial tension, but not uniaxial compression, along the uniaxial direction (e.g., to perform a monotonic tension test).

In a refinement, the first collet-chuck element is mounted to a load-applying element of the loading system (e.g., an element adapted to provide uniaxial tension and optionally uniaxial compression); and the second collet-chuck element is mounted to a (stationary) support surface of the loading system.

In a refinement, each collet-chuck element comprises: a chuck receiving element (i) adapted to receive a collet (e.g., chuck receiving element defining an open, tapered conical frustum volume sized and shaped to receive a corresponding collet), and (ii) adapted to be mounted (or secured) to the loading system; a collet adapted to be seated in the chuck receiving element, the collet defining a gripping sleeve (e.g., a conical frustum defining a cylindrical hole or recess) adapted to receive and secure the specimen therein upon compression; and a chuck sealing element adapted to secure the collet in the chuck receiving element (e.g., a threaded cap, sealed with bolts, etc.) and apply compressive force to the collet for gripping.

In a refinement, the specimen has a cylindrical shape defining a cylindrical axis, and having a length (L) and a circular diameter (D); the specimen has an aspect ratio (L/D) of at least 1 (e.g., at least 1, 1.5, 2, 2.5, or 3 and/or up to 2, 4, 6, 8, or 10); the specimen has a diameter in a range of 10 mm to 150 mm (e.g., at least 10, 20, 30, 40 or 50 mm and/or up to 20, 40, 60, 80, 100, or 150 mm); and/or the cylindrical axis of the specimen is aligned with (e.g., collinear with) the uniaxial direction of the loading system when the specimen is mounted (or secured) in the first and second collet-chuck elements.

In a refinement, the specimen comprises asphalt (or asphalt concrete), or other composite or polymer material.

In a refinement, the specimen is selected from the group consisting of concrete, polymers (e.g., thermosets, thermoplastics, composites thereof), and metals (e.g., steel, aluminum).

In a refinement, the apparatus further comprises one or more strain sensors adapted to measure (uniaxial) strain in the specimen (e.g., when the specimen is present). In a further refinement, the one or more strain sensors comprise on-specimen strain sensors (e.g., linear variable differential transformer (LVDT), strain gauge, or other strain sensor mounted to or otherwise in contact with the specimen during strain measurement). In an additional or alternative refinement, the one or more strain sensors comprise off-specimen strain sensors.

In a refinement, the loading system is adapted to apply rotational torsion to a solid specimen (e.g., torsion around a cylindrical axis of the specimen) secured by the first and second collet-chuck elements.

In a refinement, the apparatus further comprises a carousel unit adapted to move (e.g., rotate) between (i) a first position in which a specimen can be removed from or inserted into the first and second collet-chuck elements (e.g., with the elements disengaged from the loading system), and (ii) a second position in which the first and second collet-chuck elements containing a specimen therein are engaged with the loading system for uniaxial testing of the specimen.

In a refinement, the first and second collet-chuck elements allow rapid specimen replacement such that (i) a previously tested specimen can be removed from the first and second collet-chuck elements, and (ii) a new specimen for testing can be mounted in the first and second collet-chuck elements in 10 minutes or less (e.g., at least 0.1, 0.2, 0.5, or 1 minute and/or up to 2, 5, or 10 minutes).

In another aspect, the disclosure relates to a method for testing uniaxial strain in a solid specimen, the method comprising: mounting a specimen in the first and second support elements (e.g., first and second collet-chuck elements) of an apparatus for uniaxial testing according to any of the variously disclosed aspect, embodiments, and refinements; applying uniaxial tension and optionally uniaxial compression along the uniaxial direction of the loading system (e.g., time-dependent cyclic tension and compression or monotonic tension); and measuring strain in the specimen resulting from the uniaxial tension and optional uniaxial compression with one or more strain sensors (e.g., and recording/storing stress-strain properties of the specimen to determine or characterize failure or strength properties of the specimen).

Various refinements of the method for testing uniaxial strain are possible.

In a refinement, the method further comprises: pre-conditioning the specimen in a controlled-temperature environment external to the apparatus (e.g., specimen achieves the same temperature for the eventual strain testing environment, which can be different from ambient temperature, such as by at least 2, 4, 6, 8, or 10° C.); removing the specimen from the controlled-temperature environment and then mounting the specimen in the first and second collet-chuck elements of the apparatus (e.g., where the specimen is generally exposed to the ambient environment and can cool or warm accordingly); re-conditioning the specimen in the apparatus to achieve a selected testing temperature (e.g., the same temperature as in the controlled-temperature environment; suitably the re-conditioning time is low because specimen loading times are short and the specimen does not substantially cool or warm during loading); and after re-conditioning, applying the uniaxial tension and optionally the uniaxial compression along the uniaxial direction of the loading system.

In a refinement, the one or more strain sensors comprise off-specimen strain sensors.

In a refinement, the one or more strain sensors comprise off-specimen optical strain sensors (e.g., one, two, three, four, or more cameras directed at the specimen at one or more different axial locations of the specimen and/or one or more different angular/circumferential locations of the specimen).

In a further refinement, measuring strain in the specimen comprises: acquiring images with the optical strain sensor(s) of the specimen at a plurality of points in time during application of uniaxial tension and optionally uniaxial compression (e.g., using a computer for controlled acquisition timing and electronic storage of the images); determining displacements between successive images (e.g., images at successive/different points in time in a time series measurement) of two or more selected strain measurement points (or areas/locations) on the specimen; and determining the strain from the displacements between successive images (e.g., as a dimensionless ratio between optical flow vectors at two different strain measurement points relative to initial distance between the two different strain measurement points). The strain measurement point can be a user-specified or computer-selected area around a point of interest on the specimen, for example where the inhomogeneous nature of the specimen provides surface texture patterns that can be identified and spatially tracked between successive images (e.g., as in an asphalt concrete composite sample with characteristic light/dark contrasting patterns resulting from the aggregate and asphalt binder therein).

While the disclosed apparatus, systems, processes, methods and compositions are susceptible of embodiments in various forms, specific embodiments of the disclosure are illustrated (and will hereafter be described) with the understanding that the disclosure is intended to be illustrative and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is schematic of an apparatus for uniaxial testing in a solid specimen according to the disclosure.

FIG. 2 illustrates perspective views of components of a collet-chuck element according to the disclosure.

FIG. 3 is flowchart illustrating steps in a method for testing uniaxial strain in a solid specimen according to the disclosure.

FIG. 4 shows the dynamic modulus (top) and phase angle (bottom) master curves for a VA-SM9.5E asphalt concrete mixture.

FIG. 5 shows the dynamic modulus (top) and phase angle (bottom) master curves for a MI-4E30 asphalt concrete mixture.

FIG. 6 shows the measured cumulative (1-C) parameter vs. Nr (cycles) in uniaxial testing for glued-endplate specimens and collet-chuck specimens of the VA asphalt concrete mixtures.

FIG. 7 shows the measured cumulative (1-C) parameter vs. Nr (cycles) in uniaxial testing for glued-endplate specimens and collet-chuck specimens of the MI asphalt concrete mixtures.

While the disclosed apparatus, compositions, articles, and methods are susceptible of embodiments in various forms, specific embodiments of the disclosure are illustrated in the drawings (and will hereafter be described) with the understanding that the disclosure is intended to be illustrative and is not intended to limit the claims to the specific embodiments described and illustrated herein.

### DETAILED DESCRIPTION

The disclosure relates to apparatus and methods for uniaxial testing of a solid specimen, such as an asphalt or asphalt concrete specimen. The testing apparatus addresses limitations of current testing methods by providing a simplified and accelerated procedure for mounting and testing asphalt mixture samples and other solid specimens under uniaxial tension and/or compression, in particular to measure corresponding uniaxial strain and/or fatigue in the specimen. This can reduce the overall testing time while still providing high-quality test results. The disclosed apparatus incorporates a clamping system such as two opposing collet-chuck elements to rapidly mount and fixedly hold a solid specimen in place in a loading system, for example an asphalt mixture performance tester (AMPT) or a universal testing machine (UTM) to apply uniaxial loads, thereby eliminating the need for glued endplates currently used in standard test methods (e.g., AASHTO TP 132). The disclosure further relates to an off-specimen means for measuring strain in a specimen using optical imaging in which successive time series images of a specimen during uniaxial loading can be analyzed to determine displacements and corresponding strains. This off-specimen approach to strain measurement provides accurate strain measurements, and it further reduces the overall testing time relative to typical on-specimen strain measurements by eliminating the time required time to affix and remove on-specimen sensors in between successive measurements.

### Uniaxial Testing Apparatus

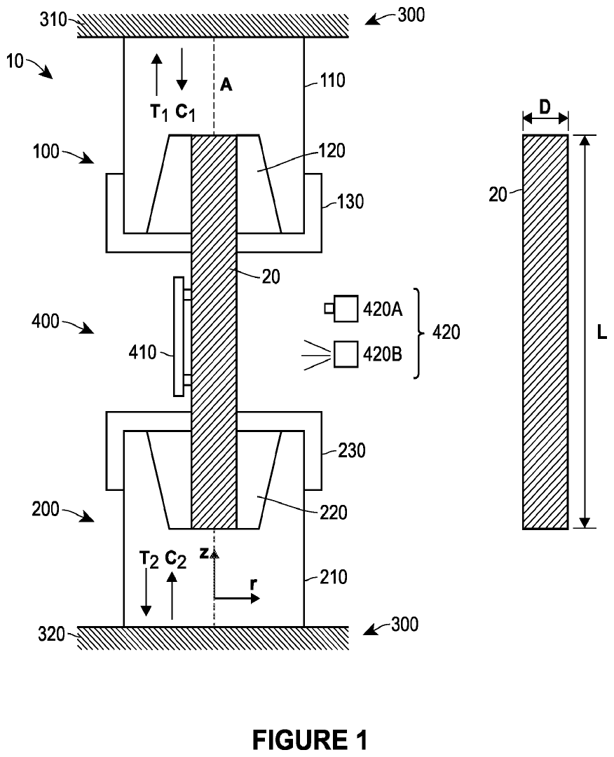

FIG. 1 illustrates an apparatus 10 for uniaxial testing in a solid specimen 20 according to the disclosure. Uniaxial testing can include uniaxial strain testing, such as in a cyclic uniaxial fatigue test for an asphalt concrete or other solid specimen. The apparatus 10 generally includes a loading system 300 having a first collet-chuck element 100 and a second collet-chuck element 200 mounted thereto. The first collet-chuck element 100 and the second collet-chuck element 200 are mounted to the loading system 300 in an opposing (or facing) orientation, such that the elements 100, 200 are adapted to receive and secure therein the solid specimen 20. During uniaxial testing, the loading system 300 applies uniaxial tension and/or uniaxial compression to the solid specimen 20 (e.g., along a cylindrical axis of the specimen) secured by the first and second collet-chuck elements 100, 200.

The loading system 300 is not particularly limited and can generally include apparatus known in the art to apply uniaxial tension and optionally uniaxial compression along a uniaxial direction, for example in a single linear direction. A suitable loading system 300 can include an asphalt mixture performance tester (AMPT) for the specific case of testing asphalt or asphalt concrete specimens. More generally, the loading system 300 can include a conventional tensile testing apparatus such as a universal testing machine (UTM) to test the tensile strength and compressive strength of materials. The loading system 300 generally can include a load frame with one, two, or more supports for holding a specimen, a crosshead moveable up and down in an axial direction for application of uniaxial tension and compression, load cell or force transducer for measuring the applied load, and/or an environmental conditioning chamber enclosing the loading system 300 and/or the specimen 20 to control/maintain one or more of temperature, humidity, and pressure during operation.

As illustrated in FIG. 1, the loading system 300 can include a load-applying element 310 and an opposing support surface 320 to which the first collet-chuck element 100 and the second collet-chuck element 200 are mounted, respectively, such that their receiving elements are facing each other and are adapted to secure the specimen 20 therein. The load-applying element 310 is adapted to provide uniaxial tension T₁ and/or uniaxial compression C₁, for example being a component of or otherwise connected to a crosshead or means for applying uniaxial force. As illustrated, the uniaxial tension T₁ and compression C₁ are in a direction generally aligned with an axis or longitudinal direction A defined by the opposing load-applying element 310 and support surface 320, which is generally also aligned or coaxial with a central axis of the specimen 20. FIG. 1 further illustrates the r-z directions of a cylindrical coordinate system in which the z-direction is generally the direction of uniaxial compression, tension, and resulting strain in the specimen 20. In some embodiments, the loading system 300 is adapted to apply both uniaxial tension T₁ and uniaxial compression C₁ along the uniaxial direction z, for example to perform either a cyclic tension/compression test or to perform a monotonic tension test. In some embodiments, the loading system 300 is adapted to apply uniaxial tension T₁, but not uniaxial compression C₁, along the uniaxial direction z, for example to perform a monotonic tension test. In some embodiments, the support surface 320 is stationary (e.g., fixed and immovable, or held fixed in place during testing) such that compression and/or tension are applied by the load-applying element 310 alone. In other embodiments, the support surface 320 can be moveable or be adapted to provide uniaxial tension T₂ and/or uniaxial compression C₂ analogous to the load-applying element 310. As illustrated, the uniaxial tension T₂ and compression C₂ are in a direction generally aligned with the axis A and the uniaxial direction z.

In some embodiments, the loading system 300 is adapted to apply rotational torsion to the solid specimen 20 in addition to uniaxial tension or compression. For example, when the specimen 20 is secured by the first and second collet-chuck elements 100, 200, the load-applying element 310 can apply a torque around a longitudinal axis A of the specimen 20, thereby inducing a torsion or rotational strain in the specimen 20 to be measured with corresponding sensors.

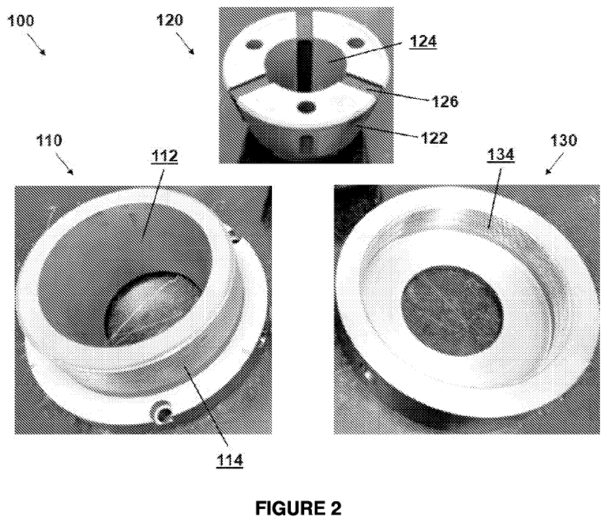

As illustrated in FIGS. 1 and 2, the first collet-chuck element 100 includes a chuck receiving element 110, a collet 120, and a chuck sealing element 130. The chuck receiving element 110 is adapted to receive the collet 100, for example where the chuck receiving element 110 defines an open, tapered conical frustum volume 112 sized and shaped to receive a corresponding collet 120. The chuck receiving element 110 is also adapted to be mounted (or secured) to the loading system 300, for example via screws, bolt, or other mounting means (not shown). The collet 120 is adapted to be seated in the chuck receiving element 110, for example having a conical frustum 122 shape or sidewall that is complementary to the conical frustum volume 112 of the chuck receiving element 110. The collet 120 defines a gripping sleeve 124, for example in the shape of a central cylindrical hole or recess defined by the conical frustum 122. The gripping sleeve 124 is sized and shaped so that it adapted to receive and secure the specimen 20 therein upon axial compression of the collet 120 when the chuck receiving and sealing elements 110, 130 are mated and tightened together. As particularly shown in FIG. 2, the collet 120 includes a plurality of rubber flexes 126 in circumferential gaps, which permit radial compression and tightening of the gripping sleeve 124 upon tightening of the chuck receiving and sealing elements 110, 130. The rubber flexes 126 permit the collet 120 to be re-used for securing and testing subsequent specimens 20, for example the rubber or other resilient material allows removal of a tested specimen 20 and insertion of a fresh specimen 20. The chuck sealing element 130 is adapted to secure the collet 120 in the chuck receiving element 110. For example, the chuck receiving and sealing elements 110, 130 can include complementary threaded portions 114, 134, respectively, that allow the collet-chuck element 100 to be assembled and apply a radial compressive force to the collet 120 for gripping the specimen 20 in the gripping sleeve 124. The second collet-chuck element 200 likewise includes a chuck receiving element 210, a collet 220, and a chuck sealing element 230 with analogous structures and components to those of the first collet-chuck element 100. As illustrated in FIG. 1, the first and second collet-chuck elements 100, 200 are mounted in an opposing orientation such that their corresponding gripping sleeves face each other.

The apparatus 10 can include one or more strain sensors 400 that are adapted to measure (uniaxial) strain in the specimen 20 when present and being subjected to uniaxial tension and/or compression by the loading system 300. Such strain sensors 400 are generally known in the art and are not particularly limited. In some embodiments, the strain sensors 400 can include one or more on-specimen strain sensors 410 that are mounted to or otherwise in contact with the specimen 20 during strain measurement. Examples of such on-specimen strain sensors 410 include a linear variable differential transformer (LVDT), a strain gauge, etc. Although FIG. 1 illustrates a single on-specimen strain sensor 410, multiple (e.g., 2, 3, 4, or more) sensors 410 can be used, for example being mounted to the specimen 20 at different angular positions and/or at different axial positions relative to the specimen 20.

In some embodiments, the strain sensors 400 can include one or more off-specimen strain sensors 420 that are not mounted to or otherwise in contact with the specimen 20 during strain measurement. Such strain sensors 420 can be positioned external to an environmental chamber (not shown) for the apparatus 10 that maintains the specimen 20 at controlled conditions during measurement. The environmental chamber suitably is formed from or contains regions formed from optically transparent materials (e.g., glass, quartz, transparent plastic/polymer), in particular when the off-specimen strain sensors 420 rely on optical and/or imaging sensing techniques. As illustrated, the off-specimen strain sensors 420 can include a camera 420A or other optical imaging sensor, for example in combination with a light source 420B to image and illuminate the specimen 20 during testing, respectively. Although FIG. 1 illustrates a single off-specimen camera 420A and light source 420B, multiple (e.g., 2, 3, 4, or more) cameras 420A and/or light sources 420B can be used, for example being positioned at different angular positions and/or at different axial positions relative to the specimen 20 (i.e., based on the field of view and area of illumination for the different components). As described herein, the camera(s) 420A can be used in optical imaging process in which successive time series images of a specimen 20 during uniaxial loading can be analyzed to determine displacements and corresponding strains in the specimen 20.

As described above, the ability to easily tighten and loosen the collet-chuck elements 100, 200 allows rapid specimen 20 replacement between testing runs in which a tested specimen 20 is removed and a fresh specimen 20 is inserted. Suitably, a previously tested specimen 20 can be removed from the first and second collet-chuck elements 100, 200, and a new, fresh specimen 20 for testing can be mounted therein in 10 minutes or less, for example in at least 0.1, 0.2, 0.5, or 1 minute and/or up to 2, 5, or 10 minutes.

In some embodiments, the apparatus 10 can include a carousel unit (not shown) for holding a plurality of specimens 20 for sequential uniaxial testing in the apparatus 10. Mechanical carousel units for holding, translating, rotating, etc. their individual removable/replaceable components therein are known in the art. In an embodiment, the carousel unit can be adapted to move (e.g., rotate) between (i) a first position in which a specimen 20 can be removed from or inserted into the first and second collet-chuck elements 100, 200 (e.g., with the elements 100, 200 disengaged from the loading system 300), and (ii) a second position in which the first and second collet-chuck elements 100, 200 containing a specimen 20 therein are engaged with the loading system 300 for uniaxial testing of the specimen 20.

### Solid Specimen

The specimen 20 can have any suitable size or shape depending on the material being tested, the size of the testing apparatus 10 and/or the collet-chuck elements 100, 200. A common shape of the specimen 20 is a cylindrical shape, for example resulting from a coring sample taken from a larger bulk material (e.g., a cored asphalt concrete sample). As illustrated in FIG. 1 (right), the specimen 20 can have a cylindrical shape defining a cylindrical axis (e.g., axis A as shown in the left portion of FIG. 1), and having a length L and a circular diameter D. The specimen 20 can have an aspect ratio (L/D) of at least 1, for example at least 1, 1.5, 2, 2.5, or 3 and/or up to 2, 4, 6, 8, or 10. The specimen 20 can have a diameter in a range of 10 mm to 150 mm, for example at least 10, 20, 30, 40 or 50 mm and/or up to 20, 40, 60, 80, 100, or 150 mm. As shown in the left portion of FIG. 1, the cylindrical axis of the specimen can be aligned with (e.g., collinear with) the uniaxial direction z of the loading system 300 when the specimen 20 is mounted (or secured) in the first and second collet-chuck elements 100, 200.

The specimen 20 can generally include any solid test material or sample to be tested in the apparatus 10 and to be secured by the opposing collet-chuck elements 100, 200. Examples of common materials for the specimen 20 include concrete (e.g., aggregate with a cement binder but no asphalt binder), polymers (e.g., thermosets, thermoplastics, composites thereof), and metals (e.g., steel, aluminum). In an embodiment, the specimen 20 can be or otherwise include asphalt, for example asphalt mixture or asphalt concrete. An asphalt mixture or asphalt concrete is generally formed by mixing aggregate with an asphalt binder to provide an asphalt concrete composition, which is generally in a solid or rigid state at common ambient environmental or use temperatures (e.g., at least-10, 0, 10, 15, or 20° C. and/or up to 25, 30, 35, 40, or 45° C.).

Asphalt binder (alternatively referenced as binder, asphalt cement, or bitumen) is suitably formed a crude oil/petroleum distillate (heavy fraction). It is a highly viscous, liquid/semi-solid colloidal material including various maltenes in a continuous phase and various asphaltenes (e.g., heteroaromatic polycyclic hydrocarbons) as a dispersed phase. Asphalt binder can include various additives, such as polymeric materials (e.g., thermoplastic, thermoset), including various elastomers, rubbers, plastomers, etc. Asphalt binders can be specified according to their “performance grade” classification in the general form “PG X Y” as generally understood by the skilled artisan and corresponding to various physical properties of the asphalt binder. The value for “X” represents the average 7-day maximum pavement design temperature (° C.), and it can include values of 46, 52, 58, 64, 70, 76, or 82° C., as well as any ranges or sub-ranges therebetween. The value for “Y” represents the 1-day minimum pavement design temperature (° C.), and it can include values of −10, −16, −22, −28, −34, −40, or −46° C., as well as any ranges or sub-ranges therebetween.

The aggregate material can include one or more of stone, gravel, sand, and mixtures thereof. The aggregate can be classified/selected according to an aggregate characteristic size, which can correspond, for example, to the largest, median, or smallest size particle in the aggregate particle size distribution, such as 37.5 mm (1.5 in sieve passing), 25.0 mm (1 in), 19.0 mm (0.75 in), 12.5 mm (0.5 in), 9.5 mm (0.375 in), 4.75 mm (No. 4), 2.36 mm (No. 8), 1.18 mm (No. 16), 0.60 mm (No. 30), 0.30 mm (No. 50), 0.15 mm (No. 100), 0.075 mm (No. 200), or ranges therebetween, based on standard sieve sizes/techniques. In some embodiments, the asphalt binder is present in an amount ranging from 2 wt. % to 10 wt. % relative to the asphalt mixture or asphalt concrete composition, for example at least 2 wt. %, 3 wt. %, or 4 wt. % and/or up to 5 wt. %, 6 wt. %, 8 wt. %, or 10 wt. %. In some embodiments, the aggregate is present in an amount ranging from 90 wt. % to 98 wt. % relative to the asphalt mixture or asphalt concrete composition, for example at least 90 wt. %, 92 wt. %, 94 wt. %, or 95 wt. % and/or up to 96 wt. %, 97 wt. %, 98 wt. %.

### Methods of Operation

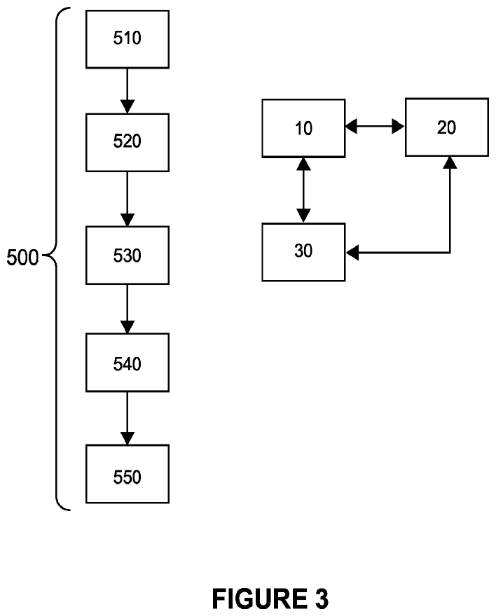

FIG. 3 is flowchart illustrating steps in a method 500 for testing uniaxial strain in a solid specimen 20. The method 500 can be performed using the uniaxial testing apparatus 10 described herein. In some embodiments, for example when using off-specimen optical imaging sensors 420, the method 500 can be performed using a conventional uniaxial testing apparatus. A conventional uniaxial testing apparatus can be represented by FIG. 1 in which the first and second collet-chuck elements 100, 200 are omitted, and the specimen 20 is glued to opposing endplates during testing (e.g., at or on surface 310, 320 in FIG. 1).

The method 500 can include pre-conditioning 510 the specimen 20 in a controlled-temperature environment external to the apparatus. The pre-conditioning step is optional, but is suitably performed so that the specimen 20 achieves a selected or desired temperature for the eventual strain testing environment, which can be different from the ambient temperature, such as by at least 2, 4, 6, 8, or 10° C. The specimen 20 is removed from the controlled-temperature environment (if pre-conditioned), and the specimen 20 is then mounted 520 in the first and second collet-chuck elements 100, 200 of the uniaxial testing apparatus, for example inside the environmental chamber thereof. During this transfer, the specimen 20 is generally exposed to the ambient environment and can cool or warm based on its temperature relative to ambient. The specimen 20 can then be re-conditioned 530 in the uniaxial testing apparatus to achieve a selected testing temperature, for example the same temperature as in the controlled-temperature environment. Suitably the re-conditioning time is low because specimen 20 loading times are short and the specimen 20 does not substantially cool or warm during loading, thus further reducing analysis cycle time. After re-conditioning 530 (if performed), uniaxial tension and/or uniaxial compression are applied 540 along the uniaxial direction z of the loading system 300. The loading can include time-dependent cyclic tension and compression, or just monotonic tension, depending on the particular uniaxial strain test being performed. The strain in the specimen 20 resulting from the uniaxial tension and/or uniaxial compression is then measured 550 with one or more strain sensors 400. The measurement 550 can include recording/storing stress-strain properties of the specimen 20 to determine or characterize failure or strength properties of the specimen 20. As illustrated in FIG. 3, a computer 30 can be included in combination with a uniaxial testing apparatus, such as the apparatus 10 according to the disclosure or a conventional apparatus, for example as a kit or measurement system including both components. The computer can generally include a processor, memory, and software configured or adapted to control operation of the uniaxial testing apparatus, for example including application of the uniaxial tension and/or uniaxial compression at specified loads and/or intervals, controlling environmental conditions within the apparatus during testing, measuring the resulting strain with one or more strain sensors, and/or recording/storing the results in a computer-readable medium.

In an embodiment, measurement 500 of strain in the specimen 20 can be performed using one or more off-specimen optical strain sensors 420A, for example including one, two, three, four, or more cameras directed at the specimen 20 at one or more different axial locations of the specimen 20 and/or one or more different angular/circumferential locations of the specimen 20. In a further embodiment, measurement 500 of strain can include acquiring images with the optical strain sensor(s) of the specimen 20 at a plurality of points in time during application of uniaxial tension and optionally uniaxial compression, determining displacements between successive images of two or more selected strain measurement points (or areas/locations) on the specimen 20, and determining the strain from the displacements between successive images. The computer 30 can be used for controlled acquisition timing and electronic storage of the images. Displacements between successive images can be determined from images at successive/different points in time in a time series measurement or video. The strain can be determined as a dimensionless ratio between optical flow vectors at two different strain measurement points relative to initial distance between the two different strain measurement points. The strain measurement point can be a user-specified or computer-selected area around a point of interest on the specimen 20, for example where the inhomogeneous nature of the specimen provides surface texture patterns that can be identified and spatially tracked between successive images, such as in an asphalt concrete composite sample with characteristic light/dark contrasting patterns resulting from the aggregate and asphalt binder therein.

### EXAMPLES

The following examples illustrate the disclosed apparatus and methods, but they are not intended to limit the scope of any claims thereto.

### Example 1—Preparation and Evaluation of Test Specimens

Test specimens were formed from two different asphalt mixtures. The first mixture was collected from Virginia Paving. The Virginia Paving mixture (referred to as VA-SM9.5E or VA mix) is a dense-graded surface mixture with a nominal maximum aggregate size (NMAS) of 9.5 mm (SM-9.5E) 50-gyration design with 15 wt. % reclaimed asphalt pavement (RAP) materials, a PG 64E-22 asphalt binder, and 0.3 wt. % EVOTHERM (processing temperature-reduction additive; available from Invegivty, North Charleston, SC). The second mixture was collected from Michigan Paving. The Michigan Paving mixture (referred to as MI-4E30 or MI mix) is a dense-graded surface mixture with NMAS 12.5 mm, 109-gyrations design with 21 wt. % RAP, a PG 70-28P binder, and 3.5% air voids design. All mixtures were collected at the plant.

The mixture maximum theoretical gravity (Gmm) was measured according to AASHTO T209 standard test procedure for both mixtures, and compaction trials were conducted to achieve target air voids for performance testing. Both mixtures were used to prepare test specimens of target air void content 7% with ±0.5% tolerance. Cylindrical specimens were prepared with a standard 38 mm diameter and a standard 110 mm height to run both standard dynamic modulus and uniaxial fatigue test methods on 110-mm height specimens, as well as the initial trials of the accelerated AMPT cyclic fatigue test solutions using the collet-chuck assembly. Cylindrical specimens were prepared with a standard 38 mm diameter and a 180 mm height for testing in collet-chuck assembly (e.g., as illustrated in FIG. 1) without the need for cutting the ends. Specifically, the extended length specimens eliminate the need for cutting the ends of the 38-mm diameter specimens cored from the gyratory compactor, and the extended length provides a larger contact area between the collet and the specimen to allow for sufficient frictional forces to hold specimens in place during the cyclic fatigue test. Air void measurements for various prepared specimens are summarized in Table 1 below.

TABLE 1
Air Void Measurements for Prepared Specimens

| | | | Measured Air | Measured Air | Estimated Air voids |
|---|---|---|---|---|---|
| | | | voids (%) for | voids (%) for | (%) Middle 110-mm |
| | | | 110-mm Height | 180-mm Height | portion of 180-mm |
| Test | Mix | Specimen | Specimens | Specimens | Height Specimens |
| Standard | VA | VA 2B | 6.5 | N/A | N/A |
| Dynamic | VA | VA 5A | 7.3 | N/A | N/A |
| Modulus | VA | VA 7B | 7.0 | N/A | N/A |
| Test | MI | MI 2B | 6.7 | N/A | N/A |
| | MI | MI 3C | 7.4 | N/A | N/A |
| | MI | MI 4C | 6.6 | N/A | N/A |
| Glued | VA | VA 6A | 6.6 | N/A | N/A |
| Endplates | VA | VA 4C | 6.7 | N/A | N/A |
| (Standard) | VA | VA 4A | 6.5 | N/A | N/A |
| Cyclic | MI | MI 2A | 6.9 | N/A | N/A |
| Fatigue | MI | MI 2C | 6.8 | N/A | N/A |
| Test | MI | MI 2D | 6.8 | N/A | N/A |
| Collet- | VA | VA 10C | N/A | 7.4 | 7.2 |
| Chuck | VA | VA 10A | N/A | 7.0 | 6.8 |
| Cyclic | VA | VA 11A | N/A | 7.4 | 7.2 |
| Fatigue | MI | MI 6B | N/A | 7.9 | 7.4 |
| Test | MI | MI 7C | N/A | 7.6 | 7.1 |
| | MI | MI 7D | N/A | 7.9 | 7.4 |

### Example 2—Uniaxial Testing Apparatus

A uniaxial testing apparatus according to the disclosure and as generally illustrated in FIG. 1 was assembled by incorporating two opposing collet-chuck elements into an Asphalt Mixture Performance Tester (AMPT) loading system by mounting the collet-chuck elements at opposing load-applying and support surfaces of the AMPT. The AMPT further includes an environmental chamber to control temperature and/or relative humidity of the specimen during testing. Specimens were prepared for testing outside of the AMPT environmental chamber by inserting and securing a given specimen between two opposing collet-chuck elements, typically using a fixed-height support such as wooden blocks/spacers to maintain a desired distance (e.g., 103 mm in this example) between the collet-chuck elements (e.g., axial distance between chuck sealing elements 130, 230 in FIG. 1). The support elements allow the specimen to be assembled by a single person, and they also eliminate the loading of the test specimen due to dead load of the upper collet-chuck system prior to testing. Other fixed-height support or spacer structures could be used, for example concentric C-shaped sections having an adjustable overall axial height and fitting around an outer circumference of the specimen and between the opposing collet-chuck elements. The specimen with affixed collet-chuck elements was then inserted into the AMPT environmental chamber, and the upper and lower collet-chuck elements were screwed into their respective support surfaces of the AMPT's loading system. For strain testing of a specimen, LVDT strain sensors were mounted on outer surfaces of the specimen.

### Example 3—Standard Dynamic Modulus Test Data (AASHTO TP 132)

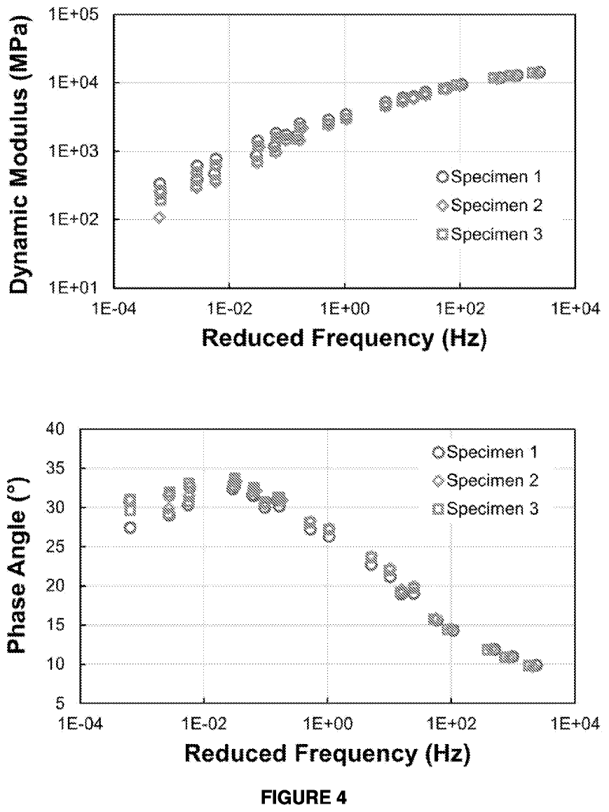

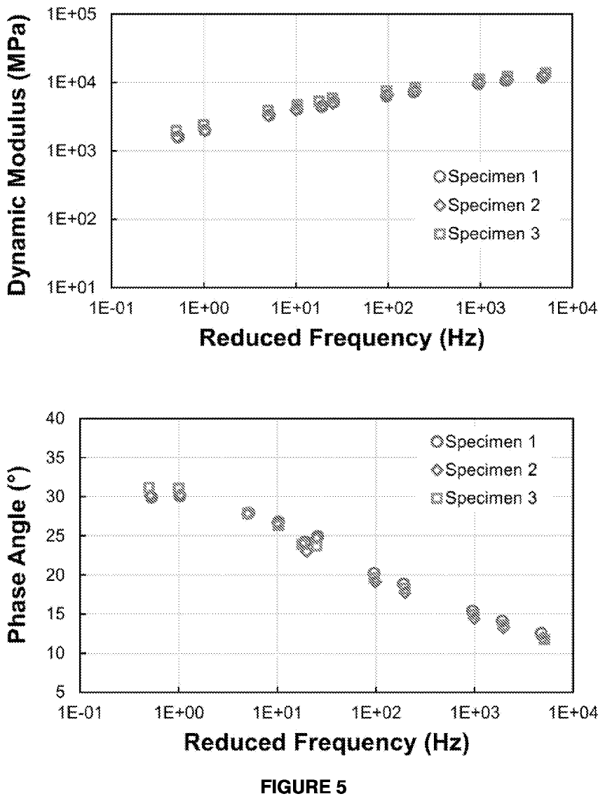

Standard dynamic modulus tests were performed on three replicates for two mixtures according to AASHTO TP 132. Dynamic modulus test data is necessary to conduct S-VECD analysis on the material level. FIGS. 4 and 5 show the dynamic modulus and phase angle master curves for VA-SM9.5E mixture and the MI-4E30 mixture, respectively. Dynamic modulus test data on small specimens shows higher variability at higher temperatures and lower frequencies. The majority of data quality indicator (DQI) warnings were observed at a 37.8° C. testing temperature.

### Example 4—Cyclic Fatigue Index

The main purpose of accelerating a uniaxial cyclic fatigue test is to facilitate its implementation in mix design approaches (e.g., balanced-mix design), and integrate mix design with pavement design, among other applications. Thus, it is important to focus on the Simplified-Viscoelastic Continuum Damage (S-VECD) model variables that may affect the cyclic fatigue index parameter (Sₐₚₚ). The cyclic fatigue index parameter is known in the art and can be characterized by uniaxial cyclic loading measurements related to the damage characteristic curve (or pseudo stiffness (C)), the damage internal state variable(S), the failure criteria based on pseudo stiffness vs. time curve (D^{R}), and the number of loading cycles (Nₜ). If these measured values are the same between different measurement techniques, then the corresponding cyclic fatigue index parameters (Sₐₚₚ) determined by the S-VECD model will also be the same.

Cyclic fatigue testing was performed for different specimens using AMPT apparatus including specimens mounted using (i) collet-chuck elements according to the disclosure, or (ii) conventional glued-endplate elements as a comparison. The AMPT instrument used UTS 032 (glued endplate) or UTS 021 (an older version for UTS 032; collet-chuck) software to run the tests and generate output files that could be analyzed to obtain C, S, and D^{R} measurement values.

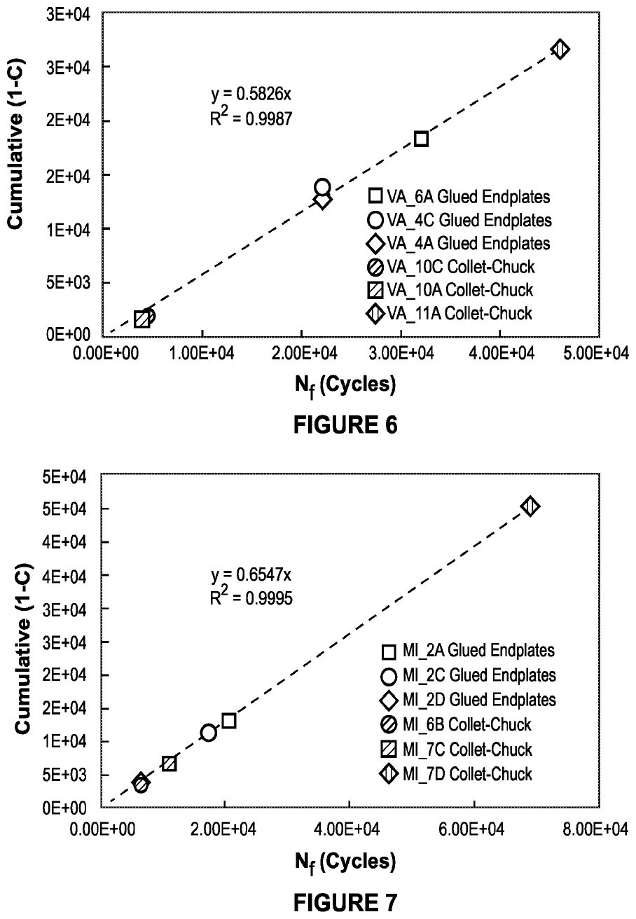

Uniaxial cyclic fatigue test was conducted on (i) the VA asphalt concrete mixture at 18° C. and (ii) the MI asphalt concrete mixture at 12° C., both according to AASHTO TP 133. C vs. S curves for the samples tested with collet-chuck and glued endplates. For the VA mixtures, the curves generally overlapped with each other, but there was not such a close comparison for the MI mixtures. Further, the value of C at failure is significantly higher for the collet-chuck curves. FIG. 6 shows the measured Cumulative (1-C) parameter vs. Nr (cycles) for glued-endplate specimens and collet-chuck specimens of the VA mixtures. The slope of the Cumulative (1-C) vs. Nr (cycles) curve is essentially equal to D^{R}. FIG. 6 demonstrates that all data points can be effectively fitted using the same linear regression line and same slope (D^{R}) with an R-squared value=0.999 and a best fit line should go through the origin. FIG. 7 shows the analogous measurements for MI mixture specimens. The measurements indicated that the average D^{R} values from the collect-chuck test set were lower than those from the standard glued-endplate test method, but both data sets were within the testing variability.

Although the cyclic fatigue results were not identical between the tests using either the collet-chuck or glued endplates, the results were generally similar enough and within testing variability such that the two methods can yield comparable cyclic fatigue index parameters (Sₐₚₚ). More specifically, based on the cyclic fatigue testing and analysis results for VA and MI mixtures, it was observed that both standard glued-endplate specimen tests (AASHTO TP 133) and the accelerated collet-chuck specimen mounting provided comparable D^{R} values that are within the testing variability. In contrast, the comparisons of C vs. S curves show that collet-chuck testing system led to lower C vs. S curves and higher C at failure in most cases.

### Example 5—Uniaxial Testing Apparatus with Off-Specimen Strain Sensor

As an alternative to on-specimen strain sensing (e.g., via LVDT sensors affixed to the specimen), a non-contact strain measurement methodology can be used to measure the strains on asphalt specimens using an optical (image processing) technique. The optical off-specimen sensing methodology accelerates the fatigue testing of asphalt mixtures by avoiding the time taken to glue the LVDT-holding studs (or otherwise affix an on-specimen sensor), install the on-specimen instrumentation, and significantly reduce the conditioning time. The off-specimen, non-contact strain measurement procedure includes four components: (i) inclusion of a camera and light sources external to the AMPT, but with optical access to the specimen therein (e.g., via transparent walls or wall sections of the AMPT environmental chamber), (ii) image capture using a developed LABVIEW algorithm, (iii) optical image processing of recorded videos (or other time series images during the uniaxial testing) to measure the strains, and (iv) comparative analysis of AMPT and optical flow (OF) code measurements. The camera used was an industrial camera (brand: BASLER 503k) with the following properties: horizontal and vertical pixel counts were 1280 and 1024 pixels, respectively; with an equipped lens, the field of view was 65 mm by 52 mm, which provided a resolution of 0.051 mm/pixel. The camera had an image capturing rate of 400 frames per second (fps). Three light sources (120 Volts and 60 Hz high intensity lights) were used to illuminate the specimen from different circumferential angles.

The developed LABVIEW algorithm controlled the image capture time and frequency of camera images during a test. An image capturing rate of 200 fps (frames or images per second) was selected because, at 200 fps, 20 displacement points per cycle can be captured during a fatigue testing frequency of 10 Hz. 20 data points are sufficient to fit a sinusoid to the data to acquire the peak-to-peak displacements. At lower fatigue test frequencies, either the frame rate can be reduced to capture 20 points per cycle or kept at 200 fps to capture more data points per cycle.

The acquired video files were processed using an Optical Flow (OF) algorithm developed in MATLAB to compute the spatial displacements of points between successive images having known time intervals. The MATLAB program takes recorded video as an input, and the strains are calculated based on the displacements observed at the selected points. The main steps involved in the strain measurement process are: (i) loading the recorded video file to the program, (ii) selection of strain measurement points, and (iii) running the phase-based points algorithm.

The term Optical Flow in the field of computer science is defined as the pattern of apparent motion of objects, surfaces, and edges in a visual scene caused by the relative motion between an observer and the scene. The phased-based optical flow algorithm computes the displacements of selected points using procedure generally including the following steps: (1) A “macro block” window is generated around a point of interest. The size of this macro block is selected to be 42 by 42 pixels, which is sufficient to capture a texture pattern around the point of interest. If the macro block size is too small, there may not be sufficient contrast and pattern of pixels for algorithm to work properly. If the macro block size is too large, then the displacement of the center point is affected by the motion of the pixels within the large macro block, reducing the accuracy. (2) The image within the macro block is cropped, and a set of spatial filters are applied. Four quadrature filters are used in this step and their phase responses are calculated. (3) A temporal phase gradient is computed for each of the four quadrature filters, from which the component velocities are calculated. (4) Component velocities from the four filters are combined to estimate the optical flow of the point of interest.

The magnitude of optical flow is essentially an incremental displacement (in pixels) of a given point between two consecutive frames. The vertical strain is calculated using the following equation (1):

$${ε}_{y} = ( {δ}_{A} - {δ}_{B} ) / {L}_{A B} \qquad ( 1 )$$

In equation (1), where ε_{y} is vertical strain, δ_{A} and δ_{S} are the optical flow vectors of two selected points A and B in consecutive images, and L_{AB} is the initial distance between the two points A and B. All units are in pixels and there is no need for conversion from pixels to physical units (e.g., mm) when strain is calculated, since strain is a dimensionless ratio of two length scales. It is noted that δ_{A} and δ_{S} are cumulative displacement vectors calculated between consecutive frames. Once the cyclic strain is computed, a pair of sinusoid and cosine functions are fitted to the data to compute the peak-to-peak displacements. For fitting, the procedure described in fitting to dynamic modulus (|E*|) test data in AASHTO T 342 standard was used.

As described in the following examples, the non-contact strain measurement methodology was tested and validated in four different cyclic fatigue test trials on both a conventional (glued-endplate) uniaxial testing apparatus and the disclosed collet-chuck uniaxial testing apparatus included. In addition, the optical image analysis algorithm was tested for three different patterns: on-specimen, printed random pattern, and spray-painted pattern. The patterns were applied to a piece of paper, then double-sided tape was used to affix the patterns on the specimens during testing.

### Example 6—Off-Specimen Strain Sensing Trial No. 1

As part of the first trial, a series of cyclic fatigue tests was conducted to validate the non-contact strain measurement methodology. In these tests, conventional cyclic fatigue tests were conducted at a loading frequency of 5 Hz and actuator peak-to-peak displacements 0.02, 0.05, 0.07, 0.1, 0.2, or 0.4 mm. The tests were conducted at 21° C. Strains incurred by the test specimen were measured by both the AMPT device (through LVDTs) and the off-specimen, non-contact image processing technique. The test specimen's surface image was used for the strain measurement in the image analysis process. The results of the first trial showed that the OF code measured average peak-to-peak strain values ranging between 150.23με and 4103.45με, while the LVDT measured strains ranged from 125.84με to 3735.38με. The correlation between the LVDT measurements and the OF code measurements was determined, and there was a good match between the LVDT strains and the OF strains as reflected by a correlation of y=0.9257 x and an R-squared value greater than 0.99 (where y is the measured LVDT strain and x is the measured OF strain).

### Example 7—Off-Specimen Strain Sensing Trial No. 2

In order to increase the efficiency of the proposed non-contact strain measurement methodology, a random speckle pattern was used in the second trial. The random speckle pattern was generated using a MATLAB algorithm and printed on a white paper. In these tests, conventional cyclic fatigue tests were conducted at loading frequencies of 1, 5, or 10 Hz and actuator peak-to-peak displacements 0.05, 0.07, or 0.1 mm. The tests were conducted at 22° C. Strains incurred by the test specimen were measured by both the AMPT device (through LVDTs) and the off-specimen, non-contact image processing technique. The test specimen's surface image was used for the strain measurement in the image analysis process. The results of the second trial showed that the OF code measured average peak-to-peak strain values ranging between 440.67με and 1031.58με, while the LVDT measured strains ranged from 424.98με to 1061.75με. The correlation between the LVDT measurements and the OF code measurements was determined, and there was a good match between the LVDT strains and the OF strains as reflected by a correlation of y=1.0493 x and an R-squared value greater than 0.99 (where y is the measured LVDT strain and x is the measured OF strain).

### Example 8—Off-Specimen Strain Sensing Trial No. 3

In the third trial, a random speckle pattern with much finer spots as compared to the second trial was prepared by spraying a white paint onto a black-painted paper. In these tests, conventional cyclic fatigue tests were conducted at loading frequencies of 1, 5, or 10 Hz, actuator peak-to-peak displacements 0.05, 0.07, or 0.1 mm, and temperatures of 20° C. or 30° C. Strains incurred by the test specimen were measured by both the AMPT device (through LVDTs) and the off-specimen, non-contact image processing technique. The test specimen's surface image was used for the strain measurement in the image analysis process. The results of the third trial showed that the OF code measured average peak-to-peak strain values ranging between 359.55με and 1117.97με, while the LVDT measured strains ranged from 370.44με and 999.13με. The correlation between the LVDT measurements and the OF code measurements was determined, and there was a good match between the LVDT strains and the OF strains as reflected by a correlation of y=0.9318 x and an R-squared value greater than 0.99 (where y is the measured LVDT strain and x is the measured OF strain).

### Example 9—Off-Specimen Strain Sensing Trial No. 4

In the fourth trial, the disclosed collet-chuck system along with the spray-painted speckle pattern of the third trial was used for the strain measurements. These tests were conducted at controlled temperature of 20° C. with loading frequencies and actuator displacements that were the same as in the third trial. Strains incurred by the test specimen were measured by both the AMPT device (through LVDTs) and the off-specimen, non-contact image processing technique. The test specimen's surface image was used for the strain measurement in the image analysis process. The results of the fourth trial showed that the OF code measured average peak-to-peak strain values ranging between 308.75με and 1057.04με, while the LVDT measured strains ranged from 288.89με and 984.3με. The correlation between the LVDT measurements and the OF code measurements was determined, and there was a good match between the LVDT strains and the OF strains as reflected by a correlation of y=0.9063 x and an R-squared value greater than 0.99 (where y is the measured LVDT strain and x is the measured OF strain).

A correlation was similarly evaluated using aggregated results from each of the first through fourth trials combined. In the aggregate, the combined data had a correlation of y=0.9063 x and an R-squared value greater than 0.99 (where y is the measured LVDT strain and x is the measured OF strain), which means that, on average, OF strain measurement results were about 7% higher than the LVDT strain measurement results. Based on error analysis of the data, the OF results were within the spatial variability between the three LVDT results. The single camera used in the OF measurements was 14 years old at the time of measurement; it is believed that the measurement accuracy and degree of correlation with LVDT measurements can be improved by using one or both of (i) more than one camera (e.g., at different interrogation angles) and (ii) a camera with higher optical resolution.

### Example 10—Finite Element Analysis

Finite element method (FEM) simulations were performed for an asphalt concrete sample specimen constrained with the collet-chuck or glued platen systems. The FEM simulations indicated that the stress within each sample is generally uniform, except near the collets. Specifically, there are stress concentrations within about 5 mm of the collets. The ratio of maximum stress near the collet to average stress within the sample is about 1.5 in both collet-chuck and the glued platens. Another observation from the simulations is that the center of the sample in the collet-chuck system is free to deform in the direction of uniaxial tension. This creates a dome-shaped deformation on both sides of the sample. Such deformation is not observed in glued platens because sample is restrained in the axial direction. These FEM simulations were performed using the linear elastic assumption in a uniaxial tension mode.

Because other modifications and changes varied to fit particular operating requirements and environments will be apparent to those skilled in the art, the disclosure is not considered limited to the example chosen for purposes of illustration and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### DRAWING ELEMENTS

10 apparatus for uniaxial testing
20 specimen
30 computer system
100 first collet-chuck element
110 chuck receiving element
112 open, tapered conical frustum volume
114 threaded portion
120 collet
122 conical frustum
124 gripping sleeve or cylindrical hole/recess
126 rubber flex or gap
130 chuck sealing element
134 threaded portion
200 second collet-chuck element
210 chuck receiving element
220 collet
230 chuck sealing element
300 loading system
310 load-applying element
320 support surface
400 strain sensor
410 on-specimen strain sensor
420 off-specimen strain sensor
420A camera or optical imaging sensor
420B light source
500 method for testing uniaxial strain
510 pre-conditioning a specimen outside apparatus
520 mounting specimen in apparatus for uniaxial testing
530 re-conditioning the specimen in the apparatus
540 applying uniaxial tension and/or uniaxial compression
550 measuring strain in the specimen
A axis/longitudinal direction of compression, tension, and specimen
C₁, C₂ uniaxial compression directions
T₁, T₂ uniaxial tension directions
r, z radial, axial directions relative to loading system compression/tension axis and specimen longitudinal axis
D specimen (cylindrical) diameter
L specimen (cylindrical) length

1. An apparatus for uniaxial testing in a solid specimen, the apparatus comprising:
a loading system adapted to apply uniaxial tension and optionally uniaxial compression along a uniaxial direction; and
a first collet-chuck element and a second collet-chuck element mounted to the loading system in an opposing orientation, the elements being adapted to receive a solid specimen;
wherein the loading system is adapted to apply uniaxial tension and optionally uniaxial compression to a solid specimen secured by the first and second collet-chuck elements.

2. The apparatus of claim 1, wherein the loading system is adapted to apply uniaxial tension and uniaxial compression along the uniaxial direction.

3. The apparatus of claim 1, wherein the loading system is adapted to apply uniaxial tension, but not uniaxial compression, along the uniaxial direction.

4. The apparatus of claim 1, wherein:
the first collet-chuck element is mounted to a load-applying element of the loading system; and
the second collet-chuck element is mounted to a support surface of the loading system.

5. The apparatus of claim 1, wherein each collet-chuck element comprises:
a chuck receiving element (i) adapted to receive a collet, and (ii) adapted to be mounted to the loading system;
a collet adapted to be seated in the chuck receiving element, the collet defining a gripping sleeve adapted to receive and secure the specimen therein upon compression; and
a chuck sealing element adapted to secure the collet in the chuck receiving element and apply compressive force to the collet for gripping.

6. The apparatus of claim 1, wherein:
the specimen has a cylindrical shape defining a cylindrical axis, and having a length (L) and a circular diameter (D);
the specimen has an aspect ratio (L/D) of at least 1;
the specimen has a diameter in a range of 10 mm to 150 mm; and
the cylindrical axis of the specimen is aligned with the uniaxial direction of the loading system when the specimen is mounted in the first and second collet-chuck elements.

7. The apparatus of claim 1, wherein the specimen comprises asphalt.

8. The apparatus of claim 1, wherein the specimen is selected from the group consisting of concrete, polymers, and metals.

9. The apparatus of claim 1, further comprising one or more strain sensors adapted to measure strain in the specimen.

10. The apparatus of claim 9, wherein the one or more strain sensors comprise on-specimen strain sensors.

11. The apparatus of claim 9, wherein the one or more strain sensors comprise off-specimen strain sensors.

12. The apparatus of claim 1, wherein the loading system is adapted to apply rotational torsion to a solid specimen secured by the first and second collet-chuck elements.

13. The apparatus of claim 1, further comprising a carousel unit adapted to move between (i) a first position in which a specimen can be removed from or inserted into the first and second collet-chuck, and (ii) a second position in which the first and second collet-chuck elements containing a specimen therein are engaged with the loading system for uniaxial testing of the specimen.

14. The apparatus of claim 1, wherein the first and second collet-chuck elements allow rapid specimen replacement such that (i) a previously tested specimen can be removed from the first and second collet-chuck elements, and (ii) a new specimen for testing can be mounted in the first and second collet-chuck elements in 10 minutes or less.

15. A method for testing uniaxial strain in a solid specimen, the method comprising:
mounting a specimen in the first and second collet-chuck elements of the apparatus according to claim 1;
applying uniaxial tension and optionally uniaxial compression along the uniaxial direction of the loading system; and
measuring strain in the specimen resulting from the uniaxial tension and optional uniaxial compression with one or more strain sensors.

16. The method of claim 15, comprising:
pre-conditioning the specimen in a controlled-temperature environment external to the apparatus;
removing the specimen from the controlled-temperature environment and then mounting the specimen in the first and second collet-chuck elements of the apparatus;
re-conditioning the specimen in the apparatus to achieve a selected testing temperature; and
after re-conditioning, applying the uniaxial tension and optionally the uniaxial compression along the uniaxial direction of the loading system.

17. The method of claim 15, wherein:
the first collet-chuck element is mounted to a load-applying element of the loading system;
the second collet-chuck element is mounted to a support surface of the loading system; and
each collet-chuck element comprises:
a chuck receiving element (i) adapted to receive a collet, and (ii) adapted to be mounted to the loading system;
a collet adapted to be seated in the chuck receiving element, the collet defining a gripping sleeve adapted to receive and secure the specimen therein upon compression; and
a chuck sealing element adapted to secure the collet in the chuck receiving element and apply compressive force to the collet for gripping.

18. The method of claim 17, wherein the specimen comprises asphalt.

19. The method of claim 17, wherein the specimen is selected from the group consisting of concrete, polymers, and metals.

20. The apparatus of claim 1, wherein:
the first collet-chuck element is mounted to a load-applying element of the loading system;
the second collet-chuck element is mounted to a support surface of the loading system;
each collet-chuck element comprises:
a chuck receiving element (i) adapted to receive a collet, and (ii) adapted to be mounted to the loading system;
a collet adapted to be seated in the chuck receiving element, the collet defining a gripping sleeve adapted to receive and secure the specimen therein upon compression; and
a chuck sealing element adapted to secure the collet in the chuck receiving element and apply compressive force to the collet for gripping; and
the apparatus further comprises one or more strain sensors adapted to measure strain in the specimen.
